(19) United States
(12) Patent Application Publication
(10) Pub. No.: US 2004/0139870 A1
(43) Pub. Date: Jul. 22, 2004

(54) Drive mechanism of a printing unit

(76) Inventor: Bernd Kurt Masuch, Kurnach (DE)

Correspondence Address: Douglas R Hanscom, Jones Tullar & Cooper, Eads Station, P O Box 2266, Arlington, VA, 22202, US

(21) Appl. No.: 10/471,759

(22) PCT Filed: Feb. 5, 2002
(86) PCT No.: PCT/DE02/00415

(30) Foreign Application Priority Data
Mar. 26, 2001 (DE) 101 14 801.1
Nov. 8, 2001 (DE) 101 54 838.9

(51) Int. Cl. B41F 13/008

(52) U.S. Cl. 101/216

(57) ABSTRACT

The invention relates to a drive mechanism of a printing unit, having an axially movable form cylinder (01) and a second cylinder (02) cooperating with said form cylinder. The form cylinder can be driven by a drive motor (03) by means of a gear (10; 29) having a spur toothing. The second cylinder can be driven by the form cylinder by means of a drive connection (06; 08; 23; 26).

The invention relates to a drive mechanism for a printing unit in accordance with the preambles of claims 1 or 18.

A printing group with forme and transfer cylinders driven in pairs is known from DE 44 30 693 A1, wherein the forme cylinder is driven and its output is transmitted to the transfer cylinder via spur wheels. A journal of the forme cylinder embodied as a rotor is axially displaceable in the stator for adjusting the lateral register on the forme cylinder.

EP 0 644 048 B1 discloses cylinders which are driven coupled in pairs. The possibility of coupling an associated inking system with the driving connection of the pair is mentioned. In a schematic representation the transfer cylinder is driven by the drive motor, and power is transferred from the transfer cylinder to the forme cylinder, and from the forme cylinder to the inking system.

In DE 196 03 663 A1, the forme cylinder, and the transfer cylinder acting together with it, are driven in parallel by means of a motor. The forme cylinder can be axially displaced by means of a gear, and displaced in the circumferential direction in relation to the transfer cylinder by means of a helical gear. An inking system assigned to the forme cylinder can be driven by means of a spur wheel arranged on the journal of the forme cylinder.

DE 20 14 070 A1 discloses a drive mechanism for a rotary printing press, wherein driving of a pair of cylinders consisting of forme and transfer cylinder takes place on the forme cylinder. In order to produce a definite driving connection in the frictional drive of two transfer cylinders acting together, the two transfer cylinders are non-positively, but releasably connected with each other.

DE 34 09 194 A1 discloses the drive mechanism of a cylinder pair by means of a spur-toothed gear, wherein driving takes place from the drive motor via the gear to the transfer cylinder.

Driving of a four-cylinder printing unit with a drive mechanism acting on the respective forme cylinder is known from DE 20 14 753 A1, wherein at least one of the transfer cylinders driven by a respective forme cylinder can be charged with a braking moment for preventing changing of tooth faces.

It is the object of the invention to create a drive mechanism for a printing unit.

In accordance with the invention, this object is attained by means of the characteristics of claims 1 or 18.

The advantages to be realized by means of the invention consist in particular in that by means of the forme cylinder being driven, no movement of the drive motor needs to be performed in the print-on and print-off position of the transfer cylinder, such as would be the case with some direct drives of the transfer cylinder. A compromise based on such a pivot movement of the transfer cylinder in connection with the position of the drive motor and the engagement of the gear wheels when arranging the drive motor at the transfer cylinder can be omitted when the forme cylinder is being driven. In the other case, the latter can lead to tooth breakage, or to a reduction of the printing quality because of the play in the drive mechanism.

The drive mechanism of the printing unit is independent of the drive mechanism of a further cylinder or printing unit constituting a printing position with the printing unit, and it preferably does not have a mechanical, in particular a positively connected drive connection with the latter.

If only an inking system and the transfer cylinder are embodied for being brought into, or out of contact, a rigid coupling of the drive motor with a lateral frame can take place.

A spur-toothed pinion of the drive motor can transfer power directly to a spur-toothed spur wheel on the journal of the forme cylinder. The teeth and the axial movement are designed in such a way that the stability values, for example degrees of contact and breaking strength, are assured.

In another embodiment, the drive motor can be arranged directly axially in relation with the forme cylinder. In order to make possible an axial movement of the forme cylinder for a change of the lateral register, a spur-toothed gear or a coupling, which is flexible in the axial direction, can again be arranged between the journal and the drive motor. The embodiment of the drive motor with a planetary gear arranged between the rotor and the journal of the cylinder is advantageous in respect to advantageous rpm ranges, in particular in the start-up phase.

In cases wherein stability requires helical gears for the force transmission, an arrangement is of advantage wherein the pinion of the drive motor does not transfer power directly to the spur wheel of the forme cylinder. If no additional precautions were taken, with an axial movement of the forme cylinder a simultaneous displacement of the circumferential register would take place in that case. Precautions could be, for example, a simultaneous correction by means of the control device, which requires technical control outlay, or a permissible movement of the pinion in respect to the spur wheel of the forme cylinder which, however, requires guide devices, which cannot, or only with a large outlay, be produced without play in the circumferential direction. In an advantageous manner a coupling, which is flexible in the axial direction, can again be employed for the axial mobility of the forme cylinder.

Driving of the forme cylinder, namely via a spur-toothed gear, is advantageous, because the pivot movement of the transfer cylinder must be compensated, and only the forme cylinder must have a lateral register displacement device at the same time.

It is advantageous in connection with the mentioned embodiments of the drive mechanism for the forme cylinder, if an inking system assigned to the forme cylinder and, if provided, also a dampening system, are driven by the same drive motor. This saves expense and, assuming the correct gear ratio conditions, assures synchronization.

For the exact rotation of the cylinders and rollers during production, a common flow direction of the moments from the drive motor to the various units to be driven is particularly advantageous. In an advantageous embodiment this is achieved in that driving takes place from the forme cylinder to the transfer cylinder, and from the transfer cylinder to the inking system, i.e. serially. In this connection an embodiment is particularly economical wherein the driving takes place from the transfer cylinder to the inking system via a gear wheel rotatably arranged on the journal of the forme cylinder.

If the inking system and the transfer cylinder are driven in parallel, the use of auxiliary runners in case of gear wheel trains, or the use of belt drives, which are as free of play as possible, is required at least for one of the two drive trains.

The coupling, flexible in the axial direction, between the drive motor and the forme cylinder is advantageously embodied as a torsionally rigid shaft coupling which, however, is flexible or resilient in the axial direction, for example as an expansion or compensation coupling. The employment of a non-switchable, positively-connected multi-disk coupling is particularly advantageous which, in contrast to other positively-connected couplings, is almost free of play in the circumferential direction without an extensive production outlay and simultaneously makes an axial position change of the coupling itself, i.e. an axial movement of the forme cylinder, possible. The coupling is embodied to be positively-connected in the axial direction, but flexible or resilient in its length, for example by means of elastic or reversible deformation.

The definite direction of the moment flow is used for minimizing the play in the drive mechanism, and therefore for improving the printing quality.

The mechanical outlay for driving the cylinder pair can be considerably reduced by the use of a spur-toothed gear for driving the forme cylinder, while taking an out-of-contact movement, as well as a lateral register adjustment, into account.

Exemplary embodiments of the invention are represented in the drawings and will be described in greater detail in what follows.

Shown are in:

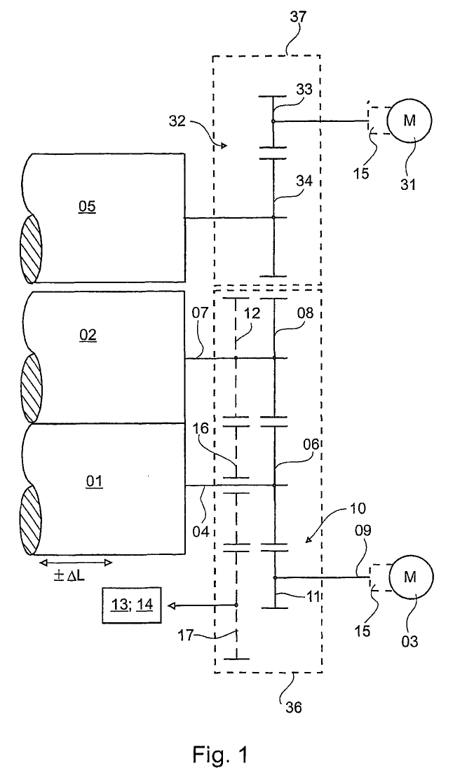

FIG. 1, a first exemplary embodiment of the drive mechanism of a printing unit,

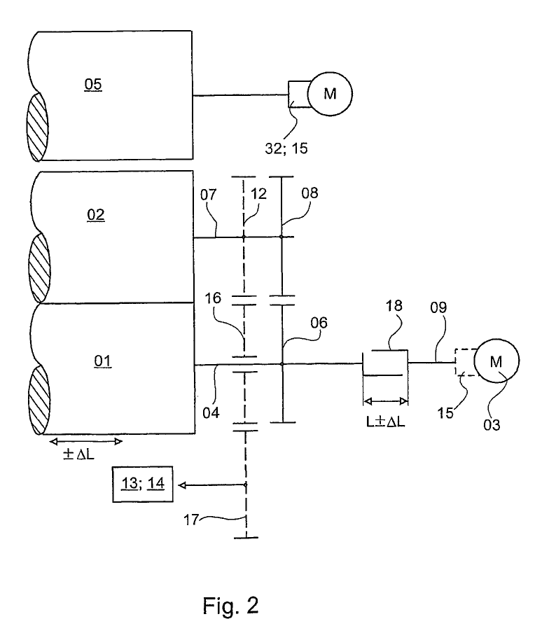

FIG. 2, a second exemplary embodiment of the drive mechanism of a printing unit,

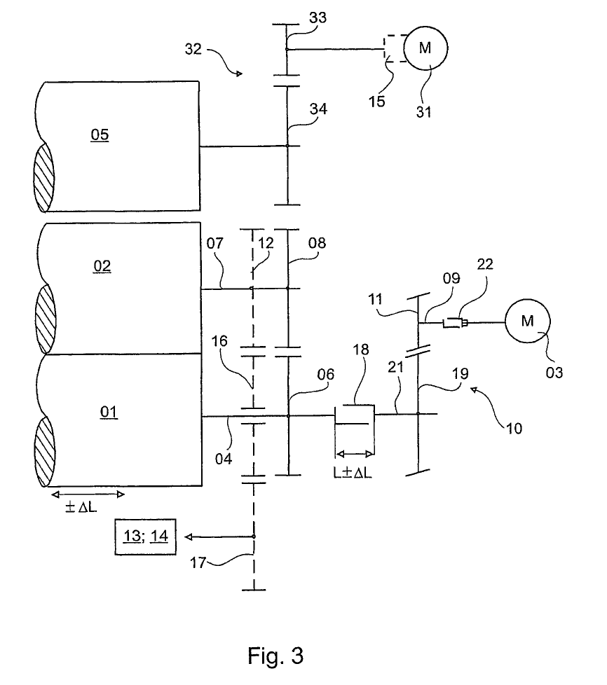

FIG. 3, a third exemplary embodiment of the drive mechanism of a printing unit,

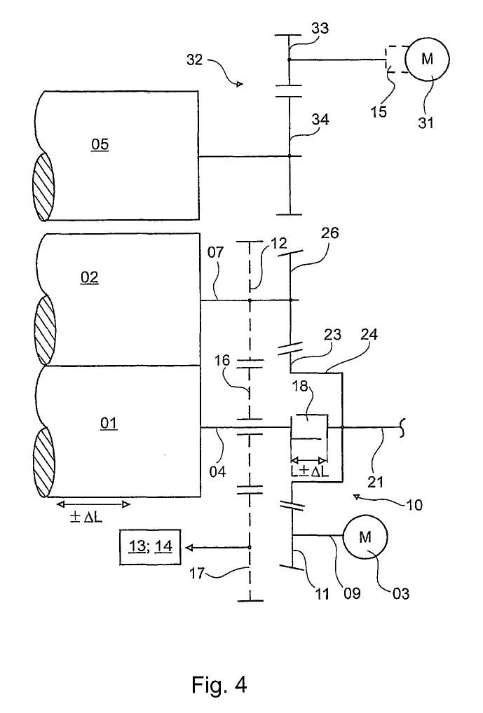

FIG. 4, a fourth exemplary embodiment of the drive mechanism of a printing unit,

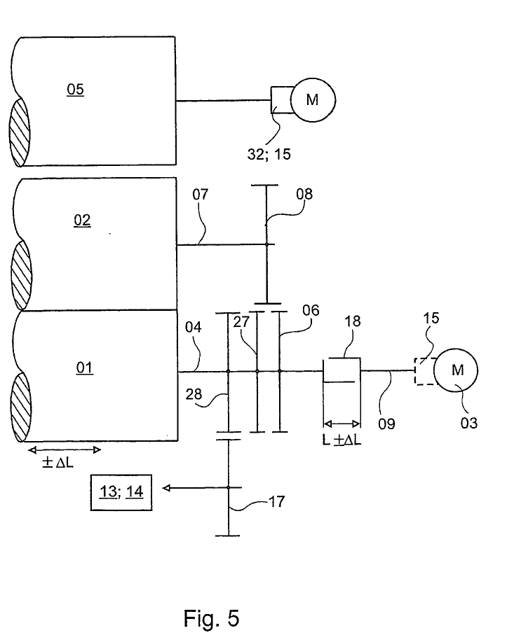

FIG. 5, a fifth exemplary embodiment of the drive mechanism of a printing unit,

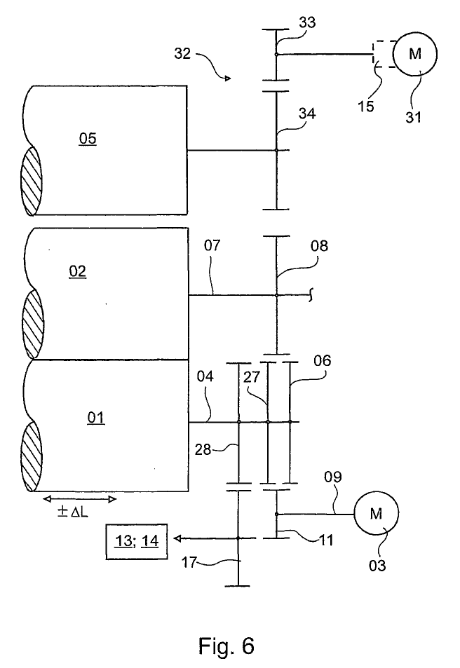

FIG. 6, a sixth exemplary embodiment of the drive mechanism of a printing unit,

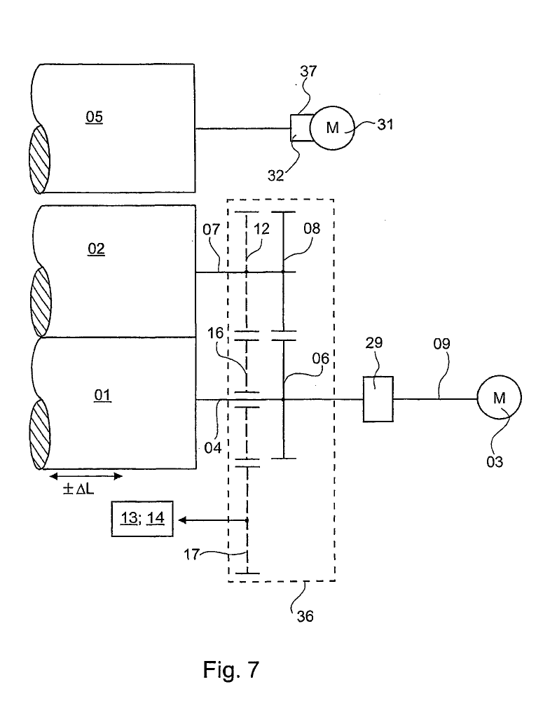

FIG. 7, a seventh exemplary embodiment of the drive mechanism of a printing unit,

A printing unit of a printing press has a first cylinder 01, for example a forme cylinder 01, and a second cylinder 02, for example a transfer cylinder 02. The two cylinders 01, 02 can be driven together by means of a drive motor 03, which is in operative connection with the forme cylinder 01, wherein the forme cylinder 01 drives the transfer cylinder 02 via a drive connection. During printing, the transfer cylinder 02 works together, and forms a printing position, with a third cylinder 05 only suggested in FIG. 1, for example a second transfer cylinder 05 of a cooperating printing unit, or for example a counter-pressure cylinder 05 which does not transfer ink, for example a satellite cylinder 05. The drive mechanism of the third cylinder 05, or that of the cooperating second printing unit, is not in a positively connected driving connection with the printing unit driven by the drive motor 03.

As represented in FIG. 1, a gear wheel 06 arranged, fixed against relative rotation, on a journal 04 of the forme cylinder 01, together with a gear wheel 08 arranged, fixed against relative rotation, on a journal 07 of the transfer cylinder 02, constitutes the driving connection between the forme cylinder 01 and the transfer cylinder 02. In an advantageous embodiment, the driving connection has at least two members 06, 08, in this case the gear wheels 06, 08, which are embodied spur-toothed and movable in relation to each other in the axial direction. In this way an axial movement becomes possible without changing the relative position in the circumferential direction.

In a first exemplary embodiment (FIG. 1), the drive of the forme cylinder 01 is provided via a gearing 10 in that a gear wheel 11, for example a pinion 11, arranged on a shaft 09 of the drive motor 03, directly drives the gear wheel 06 arranged on the journal 04 of the forme cylinder 01. The gearing 10 from the drive motor 03 to the journal 04, or to the gear wheel 06, can also be provided by means of a differently designed gear, for example via further gear wheels, via toothed belts, via bevel wheels, or in other ways.

For assuring the axial displaceability of the forme cylinder 01 (indicated by means of a two-headed arrow in FIG. 1), the pinion 11, as well as the gear wheels 06, 08, are embodied to be spur-toothed. The position and width of the pinion 11 and the gear wheel 06, 08 has been selected such that, with an axial displacement of the forme cylinder 01 by an amount Delta L, a sufficient contact of the teeth is assured. The minimum contact is of such a size that the maximum load of the teeth in respect to wear and breaking resistance is not exceeded in any of the relative positions of the gear wheels 06, 11, or of a gear designed in another way, during operations.

The same applies to the driving connection constituted by the gear wheels 06, 08. If, for example, the gear wheel 06 is embodied with a greater width and, in a zero position of the forme cylinder 01 acts together with the pinion 11 and the gear wheel 08 approximately in the center, only one of the gear wheels 06, 08, 11 of the drive train need to be embodied with a greater width.

A further reduction gear 15, for example a planetary gear 15 and/or an attached reducing gear 15 (in dashed lines), can be arranged between the drive motor 03 and the gearing 10.

A further gear wheel 12 (represented in dashed lines) is arranged, fixed against relative rotation, on the journal 07 of the transfer cylinder 02, through which an inking system 13 assigned to the forme cylinder 01 and, if provided, a dampening system 14, are driven (the inking system 13 and the dampening system 14 are shown only as reference numerals in the drawing figures).

In the present example, the gear wheel 12 drives a gear wheel 16 (represented in dashed lines), which is rotatably seated on the journal 04 of the forme cylinder 01 and which in turn meshes with a gear wheel 17 (represented in dashed lines) of a drive mechanism, not further represented, of the inking system 13 (and, if provided, of the dampening system 14).

The moment flow in the drive system from the drive motor 03 via the forme cylinder 01 to the transfer cylinder 02, and from there to the inking system 13 (and, if provided, to the dampening system 14) is definite, because it is serial. A tooth face change during load changes (putting the cylinders 01, 02, the inking system 13, the dampening system 14, in or out of contact, or changes in the conditions) is avoided to a large extent, which leads to reduced wear and in particular improved printing results.

In a second exemplary embodiment (FIG. 2), the shaft 09 of the drive motor 03 is arranged coaxially in respect to an axis of rotation of the forme cylinder 01, and is connected in a torsionally rigid manner with the journal 04 of the forme cylinder 01. In one embodiment a coupling 18, whose length L can be changed in the axial direction by an amount±Delta L, for example a coupling 18, is arranged between the drive motor 03 and the journal 04. This can be in particular an expansion coupling 18, a coupling 18 which is elastic in the axial direction, or a non-switchable shaft coupling 18 which, however is positively connected in the axial direction, but is resilient. The end of the coupling 18 facing away from the forme cylinder 01 is arranged to be fixed in place in respect to an axial direction. By means of the arrangement of the coupling 18, with the axial displacement of the forme cylinder 01 the associated drive motor 03 therefore can be arranged fixed in place, or fixed on the frame. The amount Delta L for an axial displacement of the forme cylinder 01 preferably lies between 0 and ±4 mm, in particular between 0 and ±2.5 mm, and is absorbed by the change of the length L of the coupling 06 by this amount±Delta L.

A particularly suitable coupling 18 is a flexurally elastic, all-metal coupling, also called a diaphragm or ring coupling.

A third exemplary embodiment (FIG. 3) differs from the exemplary embodiment in FIG. 2 in that the drive motor 03 is not arranged coaxially in respect to the forme cylinder 01. Power is transferred from a pinion 11 connected with the shaft 09 of the drive motor 03 to a gear wheel 19, which is connected, fixed against relative rotation, via a shaft 21 or a journal 21 with the side of the coupling 18 facing away from the forme cylinder 01. This embodiment is particularly advantageous if, because of high loads, the demands made on the stability values, for example degrees of contact and breaking strength, require helical gears on the pinion 11 and the gear wheel 19. The two cooperating gear wheels 06, 08 on the journals 04, 07 of the cylinder 01, 02 are embodied to be spur-toothed, for example, since in this way a relative movement in respect to each other is made possible without a compensation in the circumferential register being required. The inking system 13 (and, if provided the dampening system 14) can also be driven, corresponding to the second exemplary embodiment, from the transfer cylinder 02.

For the purpose of easier disassembly, or maintenance, a claw coupling 22, for example, or a coupling 22 corresponding to the coupling 18, can be arranged between the drive motor 03 and the pinion 11.

In a fourth exemplary embodiment (FIG. 4), the power transfer from the forme cylinder 01 to the transfer cylinder 02 does not take place on the side of the coupling 18 facing the forme cylinder 01, but on the side of the coupling 18 which is not movable in the axial direction. For this purpose the driving connection between the forme cylinder 01 and the transfer cylinder 02 is not arranged between the coupling 18, whose length L can be changed in the axial direction, and the forme cylinder 01, but on the side of the coupling 18 which is facing away from the forme cylinder 01 and is stationary.

For the purpose of saving space it is possible to connect a gear wheel 23 which is arranged, for example on a bushing 24 enclosing the coupling 18, with the side of the coupling 18 facing away from the forme cylinder 01. On the one side, this gear wheel 23 meshes with a gear wheel 26, which is connected, fixed against relative rotation, with the journal 07 of the transfer cylinder 02, and with the pinion 11. In comparison with FIG. 3, one drive level can be saved with this embodiment, and driving of the two cylinders 01, 31 can take place from the drive motor 03 via a helical gear. The driving connection formed by the gear wheels 23 and 26 is not located on the side of the coupling 18 facing the cylinder 01, which is to be moved axially, but on the side which is stationary in respect to an axial movement.

A fifth exemplary embodiment (FIG. 5) shows a drive for a printing unit, wherein the forme cylinder 01 is driven by means of the drive motor 03, and power is transferred parallel from the forme cylinder 01 to the drive motor 03 and the inking system 13 (and, if provided the dampening system 14). So that, in spite of an undefined direction of the moment flow, a tooth face change is prevented in the case of changing loads, the gear wheel 06, for example, arranged on the journal 04 of the forme cylinder 01, is arranged together with a further gear wheel 27, an auxiliary gear wheel 27. Power can be transferred to the gear wheel 17 leading to the drive mechanism of the inking system 13 (and, if provided the dampening system 14) via a gear wheel 28, which is also arranged, fixed against relative rotation, on the journal 04 of the form cylinder 01. For the purpose of axially displacing the forme cylinder 01, the gear wheels 06, 08, 27, and/or 17, 28, are embodied to be spur-toothed.

As represented in FIG. 5, driving of the gear wheel 06 arranged, fixed against relative rotation, on the forme cylinder 01, can take place via the coupling 18 in one of the ways represented above either coaxially in relation to the forme cylinder 01 (second exemplary embodiment, FIG. 2), or via a pinion 11, not represented in FIG. 5, in accordance with the third exemplary embodiment.

In the sixth exemplary embodiment (FIG. 6), the driving of the gear wheel 06 from the fifth exemplary embodiment, arranged fixed against relative rotation on the forme cylinder 01, takes place by means of the pinion 11 directly meshing with this gear wheel 06. Corresponding to FIG. 5, power is transmitted parallel from the gear wheel 06 to the transfer cylinder 02 and the inking system 13 (and, if provided the dampening system 14). In an advantageous embodiment, the gear wheels 06, 08, 27, and/or 17, 28, are embodied to be spur-toothed for the purpose of axially displacing the forme cylinder 01.

In a seventh exemplary embodiment (FIG. 7), the shaft 09 of the drive motor 03 is arranged coaxially in respect to an axis of rotation of the forme cylinder 01, and is connected in a torsionally rigid manner with the journal 04 of the forme cylinder 01. In an advantageous embodiment, a gear 29, for example a spur-toothed planetary gear 29, is arranged between the drive motor 03 and the journal 04, which permits an axial displacement of the forme cylinder 01 by an amount Delta L. The amount Delta L for an axial displacement of the forme cylinder 01 preferably lies between 0 and ±4 mm, in particular between 0 and ±2.5 mm, and is absorbed by the spur-teeth of the gearing, which mesh and are displaceable in respect to each other.

For all embodiment variations, in particular for the embodiment variations (FIGS. 2, 4 and 5) with a drive motor 03 arranged coaxially in respect to the forme cylinder 01, a planetary gear, not represented, can also be arranged in an advantageous further development on the drive motor 07, or between the drive motor 03 and the driving connection between the forme cylinder 01 and the transfer cylinder 02.

The driving connection 06, 08, 23, 26 between the two cylinders 01, 02, and/or the driving connection 12, 16, 17 between one of the cylinders 01, 02 and the inking system 13 (and, if required the dampening system 14), can also be provided, besides the embodiment as wheel trains 06, 08, 23, 26, or 12, 16, 17, via toothed belts (taking into consideration a reversal of the direction of rotation), or other positively-connected drive connections.

In an advantageous further development of the exemplary embodiments, the third cylinder 05, for example embodied as a satellite cylinder 05, is driven by its own drive motor 31 via a gear 32. In the example (FIG. 1), the drive motor 31 drives a pinion 33 for this purpose, which drives a gear wheel 34 arranged on the journal of the satellite cylinder 05. The gear 32 can also be embodied in different ways, for example with several gear wheels, with a belt drive, or as a reducing gear 32 arranged coaxially in respect to the satellite cylinder 05, for example a planetary gear 32, and/or as an attached gear 32 connected with the drive motor 31.

Driving of the pair consisting of the form and transfer cylinders 01, 02, as well as the satellite cylinder 05, via respectively one gear 11, 06, 33, 34 allows the selection of a suitable reduction gearing, or the employment of smaller, and similarly dimensioned, if possible, drive motors 03, 31.

An embodiment is advantageous wherein the drive mechanism of the cylinder pair 01, 02, and the drive mechanism of the satellite cylinder 05 are arranged in different lubricant chambers. For example, the driving connection 06, 08, 23, 26 between the forme and transfer cylinders 01, 02, possibly together with the driving connection 12, 16, 17, 19 to the inking system 13, if such is provided, has its own housing, in which a thin-bodied lubricant, for example, in particular oil, is contained. If not embodied directly as an auxiliary gear 15, 29 on the drive motor 03, the gear 10, 15, 29 can also be arranged in this lubricant chamber (shown by way of example in FIGS. 1 and 7).

The gearing 10 between the drive motor 03 and the drive connection 06, 08 can be arranged, individually encapsulated, in its own lubricant chamber, in particular in case where power is coaxially transmitted to the forme cylinder 01, and/or the gear 10, 15, 29, or an additional gear 15, 29, is separate from the driving connection 06, 08.

If not arranged as an attached gear 15 directly on the drive motor 31, the gear 32, 15 of the satellite cylinder 05 is arranged in a lubricant chamber inside the housing 37, which differs from the first mentioned one. In particular, this can be a lubricant chamber assigned exclusively to the satellite cylinder 05 (shown by way of example in FIGS. 1 and 7).

The manner of functioning of the drive mechanism of a printing unit is as follows:

During operation, i.e. during set-up and production operations, the cylinder 01 is driven, and by it the transfer cylinder 02. In a further development, the inking system 13 (and, if provided, the dampening system 14) is also driven by means of this drive motor 03. When the transfer cylinder 02 is pivoted in or out, the motor 03 driving the forme cylinder 02 can remain stationary and in a position for the ideal meshing of possibly cooperating pinions 11 and gear wheels 06.

If a correction of the lateral register, i.e. a lateral displacement of the printed image, is required, the cylinder 01 is displaced in the axial direction by an amount±Delta L by means of a not represented drive mechanism arranged preferably on the side of the forme cylinder 01 located opposite the drive mechanism, without the drive motor 07 also having to be displaced.

In an embodiment with a drive motor 03 which is not coaxially arranged in respect to the forme cylinder 01, an axial displacement of the forme cylinder 01, without a simultaneous displacement of the circumferential register, is possible by means of spur-toothed gearing between the gear wheel 06 and the pinion 11.

In another exemplary embodiment, the axial displacement is absorbed by the spur-toothed gearing of the gear 29, which is arranged between the drive motor 03, arranged axially in respect to the forme cylinder 01, and the forme cylinder 01.

A correction by means of an electronic shaft between the cylinders 01, 02, as well as a mechanical readjustment of the circumferential register, can be omitted.

List of Reference Symbols

01 Cylinder, first, forme cylinder

02 Cylinder, second, transfer cylinder

03 Drive motor

04 Journal (01)

05 Cylinder, third, transfer cylinder, counter-pressure cylinder, satellite cylinder

06 Gear wheel, member (04)

07 Journal (02)

08 Gear wheel, member (07)

09 Shaft (03)

10 Gearing

11 Pinion

12 Gear wheel (07)

13 Inking system

14 Dampening system

15 Gear, planetary gear, attached gear

16 Gear wheel (04)

17 Gear wheel (13)

18 Coupling, elastic, coupling, expansion coupling, shaft coupling, resilient

19 Gear wheel (21)

20 -

21 Shaft, journal

22 Coupling, claw coupling

23 Gear wheel (24)

24 Bushing

25 -

26 Gear wheel (07)

27 Gear wheel, auxiliary gear wheel (06)

28 Gear wheel (04)

29 Gear, planetary gear

30 -

31 Drive motor, second

32 Gear, planetary gear, attached gear

33 Pinion

34 Gear wheel

35 -

36 Housing

37 Housing

L Length (18)

Delta L Amount of longitudinal change (06), of the axial displacement (01)

1. A drive mechanism for a printing unit, having at least two cylinders (01, 02), namely having a forme cylinder (01), which can be axially moved by an amount (Delta L), and a transfer cylinder (02), which acts together with the forme cylinder (01) and is in a positive driving connection (06, 08, 23, 26) with it, wherein the two cylinders (01, 02) are driven by a common drive motor (03) via an at least partially spur-toothed gear (10, 29), characterized in that power is transferred from the drive motor (03) via the at least partially spur-toothed gear (10, 29) to the forme cylinder (01), and from the forme cylinder (01) to the driving connection (06, 08, 23, 26) to the transfer cylinder (02).

2. The drive mechanism in accordance with claim 1, characterized in that the driving connection (06, 08, 23, 26) between the forme cylinder (01) and the transfer cylinder (02) is embodied as a wheel train (06, 08, 23, 26).

3. The drive mechanism in accordance with claim 2, characterized in that the driving connection (06, 08, 23, 26) has a gear wheel (08, 26), which is connected, fixed against relative rotation, with a journal (07) of the transfer cylinder (02), and a gear wheel (06, 23), which acts together with the latter and is connected at least torsionally rigidly with a journal (04) of the forme cylinder (01).

4. The drive mechanism in accordance with claim 1, characterized in that the driving connection (06, 08, 23, 26) between the transfer cylinder (02) and the forme cylinder (01) is embodied by means of a toothed belt.

5. The drive mechanism in accordance with claim 1, characterized in that an inking system (03) assigned to the forme cylinder (01) has a driving connection (12, 16, 17) with the drive motor (03).

6. The drive mechanism in accordance with claim 5, characterized in that the driving connection (12, 16, 17) between the second cylinder (02) and the inking system (03) is embodied as a wheel train (12, 16, 17).

7. The drive mechanism in accordance with claim 7, characterized in that the driving connection (12, 16, 17) has a gear wheel (12), which is arranged, fixed against relative rotation, on a journal (07) of the transfer cylinder (02), and a gear wheel (16), which acts together with the latter and is rotatably seated on a journal (04) of the forme cylinder (01), and a gear wheel (17), acting together with the latter of an inking system (13).

8. The drive mechanism in accordance with claim 5, characterized in that the driving connection (12, 16, 17) between the transfer cylinder (02) and the inking system (13) is embodied by means of a toothed belt.

9. The drive mechanism in accordance with claim 1 or 2, characterized in that the inking system (13) and the second cylinder (02) can be driven in parallel from the forme cylinder (01) by means of a respective driving connection (28, 17, 06, 27, 08).

10. The drive mechanism in accordance with claim 1, characterized in that a shaft (09) of the drive motor (03) driving the forme cylinder (01) is arranged parallel and offset in respect to an axis of rotation of the forme cylinder (01).

11. The drive mechanism in accordance with claim 1, characterized in that a shaft (09) of the drive motor (03) driving the forme cylinder (01) is arranged parallel and coaxially in respect to an axis of rotation of the forme cylinder (01).

12. The drive mechanism in accordance with claim 1, characterized in that the gear (10, 29) has a pinion (09) which is connected, fixed against relative rotation, with a shaft (09), and a gear wheel (06) which is connected, fixed against relative rotation, with the forme cylinder (01).

13. The drive mechanism in accordance with claim 1, characterized in that the transfer cylinder (02) acts together with a counter-pressure cylinder (05), which has no positive driving connection with the two cylinder (01, 02).

14. The drive mechanism in accordance with claim 13, characterized in that the counter-pressure cylinder (05) is embodied as a transfer cylinder (05).

15. The drive mechanism in accordance with claim 13, characterized in that the counter-pressure cylinder (05) is embodied as a satellite cylinder (05).

16. The drive mechanism in accordance with claim 13, characterized in that the counter-pressure cylinder (05) is driven by a gear (32, 15), which is independent of the drive mechanism of the cylinder pair (01, 02).

17. The drive mechanism in accordance with claim 13, characterized in that the counter-pressure cylinder (05) can be driven by means of its own drive motor (31) via a gear (32).

18. A drive mechanism for a printing unit, having a cylinder pair (01, 02) consisting of a forme cylinder (01) and a transfer cylinder (02), which is in positive driving connection (06, 08) with the forme cylinder (01), wherein the cylinder pair (01, 02) is driven via a gear (10, 29) by a common first drive motor (03), and a counter-pressure cylinder (05), which is assigned to the cylinder pair (01, 02) is driven mechanically independently from the drive mechanism of the cylinder pair (01, 02) by means of a second drive motor (31), characterized in that a gear (32) is arranged between the second drive motor (31) and the counter-pressure cylinder (05).

19. The drive mechanism in accordance with claim 18, characterized in that the cylinder pair (01, 02) is driven from the forme cylinder (01).

20. The drive mechanism in accordance with claim 18, characterized in that the counter-pressure cylinder (05) is embodied as a satellite cylinder (05).

21. The drive mechanism in accordance with claim 1 or 18, characterized in that the gear (10, 29) between the cylinder pair (01, 02) and the drive motor (03) absorbs an axial relative movement between at least one of the cylinders (01, 02) and the drive motor (03).

22. The drive mechanism in accordance with claim 1 or 19, characterized in that the driving connection (06, 08) between the forme cylinder (01) and the transfer cylinder (02) allows an axial relative movement of the cylinders (01, 02) in respect to each other, without a relative change of the position in the circumferential direction taking place.

23. The drive mechanism in accordance with claim 1 or 19, characterized in that the driving connection (06, 08) between the forme cylinder (01) and the transfer cylinder (02) has at least one cooperating pair of spur-toothed members (06, 08) which can be moved relative to each other in the axial direction.

24. The drive mechanism in accordance with claim 19, characterized in that the gear (10, 29) between the first drive motor (03) and the forme cylinder (01) is at least partially embodied with spur teeth.

25. The drive mechanism in accordance with claim 19, characterized in that the forme cylinder (01) is axially movable by an amount (Delta L), and the drive motor (03) driving the forme cylinder (01) is arranged fixed in place on the frame.

26. The drive mechanism in accordance with claim 1 or 19, characterized in that the gear (10, 29) between the drive motor (03) and the forme cylinder (01) has at least two cooperating spur-toothed gear wheels (06, 17), and that the minimum contact of the two gear wheels (06, 11) in each axial position of the forme cylinder (01) is of sufficient size so that a maximum load on the gear teeth is not exceeded.

27. The drive mechanism in accordance with claim 1 or 18, characterized in that a portion (11, 33) of the gear (10, 26, 32) assigned to the drive motor (03, 31) is arranged fixed on the frame.

28. The drive mechanism in accordance with claim 1 or 18, characterized in that the driving connection (06, 08, 23, 26) of the cylinder pair (01, 02), and a possibly provided driving connection (12, 16, 17, 18, 17) with an inking system (13) is arranged in a first lubricant chamber.

29. The drive mechanism in accordance with claim 28, characterized in that the gear (10, 15) assigned to the cylinder pair (01, 02) is also arranged in the lubricant chamber.

30. The drive mechanism in accordance with claim 28, characterized in that the gear (10, 15) assigned to the cylinder pair (01, 02) is arranged in second lubricant chamber, which is different from the first lubricant chamber.

31. The drive mechanism in accordance with claim 16 or 18 and claim 28, characterized in that the gear (32, 15) assigned to the counter-pressure cylinder (05) is arranged in third lubricant chamber, which is different from the first lubricant chamber.

32. The drive mechanism in accordance with claim 16 or 18, characterized in that the gear (32, 15) assigned to the counter-pressure cylinder (05) has its own lubricant chamber.

33. The drive mechanism in accordance with claim 1 or 18, characterized in that the gear (10, 29) for the drive of the cylinder pair (01, 02) is embodied as a planetary gear.

34. The drive mechanism in accordance with claim 16 or 18, characterized in that the gear (32) for the drive of the counter-pressure cylinder (01, 02) is embodied as a planetary gear.

35. The drive mechanism in accordance with claim 17 or 18, characterized in that the drive motor (03, 31) has an attached gear (15, 32), which reduces the rpm.
